(19) United States
(12) Patent Application Publication
(10) Pub. No.: US 2026/0050544 A1
(43) Pub. Date: Feb. 19, 2026

(54) ACCESS TO A MEMORY DEVICE

(71) Applicant: Arm Limited, Cambridge (GB)

(72) Inventor: Michael Andrew CAMPBELL, Waterbeach (GB)

(21) Appl. No.: 18/807,114

(22) Filed: Aug. 16, 2024

(51) Int. Cl. G06F 12/02

(52) U.S. Cl. CPC G06F 12/0223

(57) ABSTRACT

Memory controllers, methods of operating memory controllers, memory devices, systems, and chip-containing products are disclosed. An access interface couples to a memory device having first and second access channels each comprising a plurality of bit-lines. A channel-select control controls activation of the first and second access channels. The access interface couples to a first subset of the first plurality of bit-lines of the first access channel ganged together with a second subset of the second plurality of bit-lines of the second access channel. Accesses to the memory device are constrained to have a minimum burst length comprising multiple data words. The channel-select control is used to activate both of the first and second access channels when the access has a first data size and to activate one of the first and second access channels when the access has a second data size which is less than the first data size.

### TECHNICAL FIELD

The present disclosure relates to data processing. In particular, the present disclosure relates to accessing a memory device.

### DESCRIPTION

Access to a memory device may be provided via an access interface supporting an access channel comprising a plurality of bit-lines. With the aim of generally increasing data throughput, accesses to the memory device may be constrained to have a minimum burst length comprising multiple data words. This then means that access to the memory device is constrained to have a minimum burst access size.

### SUMMARY

In one example described herein there is a memory controller comprising:
an access interface for coupling to a memory device, the memory device having:
   a first access channel comprising a first plurality of bit-lines; and
   a second access channel comprising a second plurality of bit-lines;
a channel-select control configured to control activation of the first access channel and of the second access channel; and
the access interface is configured to couple to a first subset of the first plurality of bit-lines of the first access channel ganged together with a second subset of the second plurality of bit-lines of the second access channel,
wherein an access to the memory device is constrained to have a minimum burst length comprising multiple data words,
and wherein the memory controller is configured to use the channel-select control to activate both of the first access channel and the second access channel when the access has a first data size; and
and wherein the memory controller is configured to use the channel-select control to activate one of the first access channel and the second access channel when the access has a second data size which is less than the first data size.

In one example described herein there is a method of operating a memory controller comprising:
coupling an access interface of the memory controller to a memory device, the memory device having:
   a first access channel comprising a first plurality of bit-lines; and
   a second access channel comprising a second plurality of bit-lines;
controlling activation of the first access channel and of the second access channel using a channel-select control;
coupling the access interface to a first subset of the first plurality of bit-lines of the first access channel ganged together with a second subset of the second plurality of bit-lines of the second access channel,
wherein an access to the memory device is constrained to have a minimum burst length comprising multiple data words;
using the channel-select control to activate both of the first access channel and the second access channel when the access has a first data size; and
using the channel-select control to activate one of the first access channel and the second access channel when the access has a second data size which is less than the first data size.

In one example described herein there is a memory device comprising:
a first access channel comprising a first plurality of bit-lines; and
a second access channel comprising a second plurality of bit-lines;
a channel-select control line to control activation of the first access channel and of the second access channel; and
a first subset of the first plurality of bit-lines of the first access channel is ganged together with a second subset of the second plurality of bit-lines of the second access channel,
wherein an access to the memory device is constrained to have a minimum burst length comprising multiple data words,
and wherein when the access has a first data size the channel-select control line activates both of the first access channel and the second access channel; and
and wherein when the access has a second data size which is less than the first data size the channel-select control line activates one of the first access channel and the second access channel.

In one example described herein there is a system comprising:
the above-mentioned memory controller, implemented in at least one packaged chip;
at least one system component; and
a board,
wherein the at least one packaged chip and the at least one system component are assembled on the board.

In one example described herein there is a chip-containing product comprising the above-mentioned system, wherein the system is assembled on a further board with at least one other product component.

### BRIEF DESCRIPTION OF THE DRAWINGS

The present invention will be described further, by way of example only, with reference to embodiments thereof as illustrated in the accompanying drawings, in which:

FIG. 1 schematically illustrates a memory controller and a memory device in accordance with some examples;

FIG. 2 is a flow diagram showing a sequence of steps that are taken in accordance with the method of some examples;

FIG. 3 schematically illustrates a data processing system comprising a memory controller and a memory device in accordance with some examples;

FIG. 4 schematically illustrates a data processing system comprising a memory controller and a memory device in accordance with some examples;

FIG. 5 schematically illustrates a data processing system comprising a memory controller and a memory device in accordance with some examples;

FIGS. 6A and 6B are flow diagrams each showing a sequence of steps that are taken in accordance with the method of some examples;

FIG. 7 schematically illustrates the transmission of data and associated error correction code data via first and second pseudo-channels in accordance with some examples;

FIG. 8 schematically illustrates the transmission of data and associated error correction code data via first and second pseudo-channels in accordance with some examples;

FIG. 9 schematically illustrates the transmission of data and associated error correction code data via first and second pseudo-channels in accordance with some examples;

FIG. 10 schematically illustrates a memory controller and a memory device in accordance with some examples; and

FIG. 11 schematically illustrates a system comprising an implementation in a packaged chip and an implementation in a chip-containing product in accordance with some examples.

### DESCRIPTION OF EXAMPLE EMBODIMENTS

Before discussing the embodiments with reference to the accompanying figures, the following description of embodiments is provided.

In accordance with one example herein there is provided a memory controller comprising:
an access interface for coupling to a memory device, the memory device having:
   a first access channel comprising a first plurality of bit-lines; and
   a second access channel comprising a second plurality of bit-lines;
a channel-select control configured to control activation of the first access channel and of the second access channel; and
the access interface is configured to couple to a first subset of the first plurality of bit-lines of the first access channel ganged together with a second subset of the second plurality of bit-lines of the second access channel,
wherein an access to the memory device is constrained to have a minimum burst length comprising multiple data words,
and wherein the memory controller is configured to use the channel-select control to activate both of the first access channel and the second access channel when the access has a first data size; and
and wherein the memory controller is configured to use the channel-select control to activate one of the first access channel and the second access channel when the access has a second data size which is less than the first data size.

An access to a memory device that imposes a minimum burst length comprising multiple data words is therefore constrained to be in blocks of data, where the size of those blocks is dependent on the minimum burst length and the interface width (i.e. the number of bit-lines forming the access interface). The inventor of the present techniques has recognised that there are circumstances when such constraints can have undesirable consequences, in particular when the size of the blocks of data into which accesses are then quantized is larger than the size of a transfer of data to or from the memory device that is desired to be carried out. To take just one example, in a situation in which the access interface has a 16-bit width and the minimum burst length is 16, this would mean that each access has a minimum size of 32 bytes. If then a number of 16-byte blocks of data should be transferred, and there is no data locality that can be exploited effectively to treat two 16B blocks of data as a single contiguous 32B block of data (i.e. this is random access), this would mean that only half of the channel capacity is used. However, the inventor of the present techniques has further realised that, for a memory device having two access channels each comprising a plurality of bit-lines, instead of the manner of coupling these two channels to the access interface being ganged (each channel permanently coupled to half of the access interface width) or being ranked (each channel can be mutually exclusively selected to provide the full access interface width), a “pseudo-channel” approach may be beneficial. The pseudo-channel configuration couples a subset (e.g. half) of each channel to the access interface, retaining the channel selection control in a manner such that when either channel is exclusively selected, the access interface is actively coupled to that subset of one of the channels, and when both channels are selected, the access interface is actively coupled to both of the respective subsets (e.g. halves) of the two channels. Accordingly, the active width of the access interface when both channels are selected is greater (e.g. is double) the active width of the access interface when just one channel is selected. With this coupling arrangement of the memory device to the access interface, the present techniques make use of its functionality, by using the channel selection control to activate both access channels when the access (“first access”) has a first data size, but using the channel selection control to activate only one of the two access channels when the access (“second access”) has a second data size which is less than the first data size. As such, accesses to the memory device may be made in a more bandwidth-efficient manner, because the minimum burst size of the second access is less than (e.g. is half) the minimum burst size of the first access.

The ability to use one or both access channels depending on the circumstances means that some accesses can be usefully parallelized, and hence in some examples the memory controller is further configured, when two accesses of the second data size to the memory device are to be performed, to use the channel-select control to activate the first access channel for a first access of the two accesses and to activate the second access channel for a second access of the two accesses.

There may be a variety of circumstances in which two accesses may differ in data size from one another, but in some examples, the access having the first data size comprises first type data and the access having the second data size comprises second type data.

Such different types of data may have a variety of sources, but in some examples the memory controller further comprises second type data generation circuitry. Hence whilst the first type data may be provided to the memory controller to conveyed via the access interface, in such examples the second type data may be generated in (or at least in close association with) the memory controller.

The generation of the second type data may occur for write accesses or for read accesses, in dependence on the particular role that the second type data is playing. However, in some examples, the memory controller is further configured, when the access is a write access to the memory device, to receive the first type data destined for the memory device, and the second type data generation circuitry is configured to generate the second type data from the first type data. Accordingly the second type data is a derivative of the first type data, such as metadata, summary data, error correction data and so on. This second type data may then also be transferred to the memory device as required.

In other examples, the access is a read access from the memory device, and the memory controller is configured to receive the first type data and the second type data from the memory device; the second type data generation circuitry is configured to generate verification second type data from the first type data; and the memory controller is configured to compare the second type data with the verification second type data. This then supports a usage, where the second type data can for example play an error identification, integrity checking, or data authentication role for the first type data, and when the first type data is received from the memory device its correctness, integrity, or authenticity can be verified by the comparison between the received second type data and the generated second type data.

The present techniques therefore provide a flexible approach to the use of the access interface, in particular as to when the first subset of the first plurality of bit-lines of the first access channel is used and when the second subset of the second plurality of bit-lines of the second access channel is used. When multiple accesses are then to be made via the access interface, and those accesses vary in size between the first data size and the second data size, the present techniques allow those accesses to make use of the access interface in a bandwidth efficient manner. In some examples, the memory controller is further configured, when two accesses of the second data size to the memory device are to be performed, to use the channel-select control to activate the first access channel for a first access of the two accesses and to activate the second access channel for a second access of the two accesses,
wherein the second type data generation circuitry is configured to generate a first instance of the second type data from a first instance of the first type data and to generate a second instance of the second type data from a second instance of the first type data,
and the memory controller is configured to transmit the first instance of the second type data and the second instance of the second type data as the two accesses of the second data size in parallel via the first access channel and the second access channel respectively,
and to transmit the first instance of the first type data via both the first access channel and the second access channel followed by the second instance of the first type data via both the first access channel and the second access channel.

One particular context in which the present techniques may be of benefit is in connection with error correction code data used to detect and where possible correct errors that arise in data values handled. Error correction code data are typically somewhat smaller in size than the data values they protect. Some other memory controllers may be provided with a separate access interface to handle such error correction code data, so that it is not transferred via the same access interface as the data values it protects. That is, the bandwidth that would otherwise be allocated solely to the transfer of data values does not need to be shared with the error protection code data for those data values. However, the present techniques are concerned with systems in which both the data values and their error protection code data share the same transfer bandwidth. Where the data values and their error protection code data have different sizes to one another, the present techniques can support a more efficient bandwidth usage for their transfer. Hence in some examples, the second data type generation circuitry is error correction code generation circuitry and the second type data is error correction code for the first type data.

The size ratio of the error correction code data to the protected data may vary. The greater the relative size of the error correction code data, the more errors can be detected per unit data and the more errors can be corrected per unit data. Conversely, the smaller the relative size of the error correction code data, the more error correction data can be transferred per unit data, in particular as supported by the present techniques allowing a parallelized transmission of smaller individual blocks of error correction code data, whereas larger blocks of protected data are transmitted occupying the full access interface width. Some examples of possible size ratios are:
a 16-bit error correction code size to a 64-bit data value (word) size, which allows for double error correction and triple error detection (DECTED) over the 64-bit word, or 16*8-bit symbols in a 64-byte line, offering 8 symbol corrections;
a 16-bit error correction code size to a 128-bit data value (word) size, which allows for single error correction and double error detection (SECDED) over the 128-bit word, or 8*8-bit symbols in a 64-byte line, offering 4 symbol corrections; and
a 16-bit error correction code size to a 256-bit data value (word) size, which allows for single error correction and double error detection (SECDED) over the 64-bit word, or 4*8-bit symbols in a 64-byte line, offering 2 symbol corrections.

Accordingly, in some examples, the error correction code generation circuitry is configured to generate the error correction code in a 16:64 bit ratio for the first type data,
and wherein the memory controller is configured to transmit a first error correction code for a first data packet and a second error correction code for a second data packet in parallel via the first access channel and the second access channel respectively,
and to transmit the first data packet via both the first access channel and the second access channel followed by the second data packet via both the first access channel and the second access channel.

Accordingly, in some examples, the error correction code generation circuitry is configured to generate the error correction code in a 16:128 bit ratio for the first type data,
and wherein the memory controller is configured to transmit a first error correction code for a first data packet and a second error correction code for a second data packet via the first access channel and in parallel to transmit a third error correction code for a third data packet and a fourth error correction code for a fourth data packet via the second access channel respectively,
and to transmit the first data packet, the second data packet, the third data packet and the fourth data packet sequentially via both the first access channel and the second access channel.

Accordingly, in some examples, the error correction code generation circuitry is configured to generate the error correction code in a 16:256 bit ratio for the first type data,
and wherein the memory controller is configured to transmit 1st to 4th error correction codes for 1st to 4th data packets via the first access channel and in parallel to transmit 5th to 8th error correction codes for 5th to 8th data packets via the second access channel respectively,
and to transmit the 1st to 8th data packets sequentially via both the first access channel and the second access channel.

The present techniques are not limited to only a first and second access channel coupling to the access interface and more access channels can also be accommodated. Accordingly, in some examples, the access interface for coupling to the memory device is configured for coupling to the memory device further having:
a third access channel comprising a third plurality of bit-lines; and
a fourth access channel comprising a fourth plurality of bit-lines;
the channel-select control is further configured to control activation of the third access channel and of the fourth access channel; and
the access interface is further configured to couple to a first subset of the third plurality of bit-lines of the third access channel ganged together with a second subset of the fourth plurality of bit-lines of the third access channel,
wherein the access comprises a first access and a second access,
and wherein the memory controller is configured to use the channel-select control to activate both of the third access channel and the fourth access channel when the second access has the first data size; and
and wherein the memory controller is configured to use the channel-select control to activate one of the third access channel and the fourth access channel when the second access has the second data size.

In some examples, the memory device is an LPDDR memory device.

In some examples, the memory device is an LPDDR5 memory device.

In some examples, the minimum burst length is 16.

In some examples, the memory device is configured to operate in byte-mode.

In accordance with one example herein there is provided a method of operating a memory controller comprising:
coupling an access interface of the memory controller to a memory device, the memory device having:
   a first access channel comprising a first plurality of bit-lines; and
   a second access channel comprising a second plurality of bit-lines;
controlling activation of the first access channel and of the second access channel using a channel-select control;
coupling the access interface to a first subset of the first plurality of bit-lines of the first access channel ganged together with a second subset of the second plurality of bit-lines of the second access channel,
wherein an access to the memory device is constrained to have a minimum burst length comprising multiple data words;
using the channel-select control to activate both of the first access channel and the second access channel when the access has a first data size; and
using the channel-select control to activate one of the first access channel and the second access channel when the access has a second data size which is less than the first data size.

In accordance with one example herein there is provided a memory device comprising:
a first access channel comprising a first plurality of bit-lines; and
a second access channel comprising a second plurality of bit-lines;
a channel-select control line to control activation of the first access channel and of the second access channel; and
a first subset of the first plurality of bit-lines of the first access channel is ganged together with a second subset of the second plurality of bit-lines of the second access channel,
wherein an access to the memory device is constrained to have a minimum burst length comprising multiple data words,
and wherein when the access has a first data size the channel-select control line activates both of the first access channel and the second access channel; and
and wherein when the access has a second data size which is less than the first data size the channel-select control line activates one of the first access channel and the second access channel.

In accordance with one example herein there is provided a system comprising:
the memory controller of any of the above discussed examples, implemented in at least one packaged chip;
at least one system component; and
a board,
wherein the at least one packaged chip and the at least one system component are assembled on the board.

In accordance with one example herein there is provided a chip-containing product comprising the above-mentioned system, wherein the system is assembled on a further board with at least one other product component.

Particular embodiments will now be described with reference to the figures.

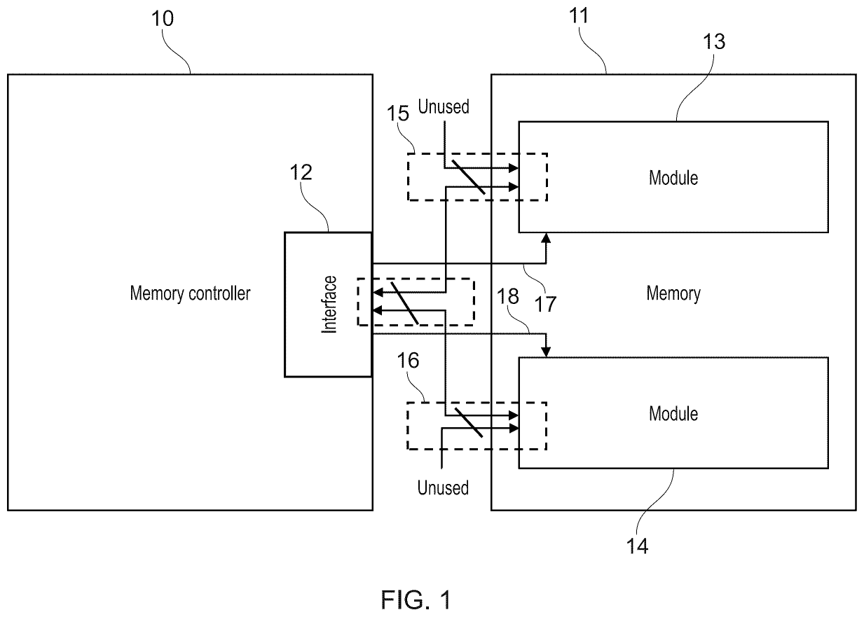

FIG. 1 schematically illustrates a memory controller 10 and a memory device 11 in accordance with some examples. The memory controller 10 comprises an access interface 12 via which it is coupled to the memory device 11. The memory device 11 is a two-channel package comprising two memory modules 13, 14. The first memory module 13 has an access channel 15 comprising a plurality of bit-lines and the second memory module 14 has an access channel 16 comprising a plurality of bit-lines. The memory controller 10 controls activation of the access channel 15 and the access channel 16 via a channel-select control, which itself comprises a signal 17 for the module 13 and a signal 18 for the module 14. Only part of each of the access channels 15 and 16 are coupled to the access interface 12. This may be achieved by running the two-channel package in “byte-mode”, with only one byte lane from each channel actively used. In the example shown each of the access channels 15 and 16 has a 16-bit width of which an 8-bit half of each are ganged together to couple to the 16-bit width access interface 12. Either or both of the channel-select control signals 17, 18 can be asserted and a given data block can thus either be transferred via just one of the access channels (at 8-bit width) or shared across both (at 16-bit width). The two access channels 15 and 16 thus operate as pseudo-channels. Accesses to the memory device 11 are constrained to have a minimum burst length of 16 in the example shown, such that an access using just one access channel has a minimum 16B block size and an access using both access channels has a minimum 32B block size. As will be discussed in more detail with reference to the figures that follow, the memory controller 10 is configured to assert both channel-select signals 17, 18 such that both of the access channels 15, 16 are used when an access has a first data size (in the example shown quantized in 32B blocks), and is configured to assert one of the two channel-select signals 17, 18 such that one of the access channels 15, 16 is used when an access has a second data size (in the example shown quantized in 16B blocks). Note that this configuration does not mean that both access channels 15, 16 cannot be used when an access has the first data size, but rather that, for any given access of the first data size, only one access channel is needed. The other access channel may well be used in parallel for another access of the first data size at the same time.

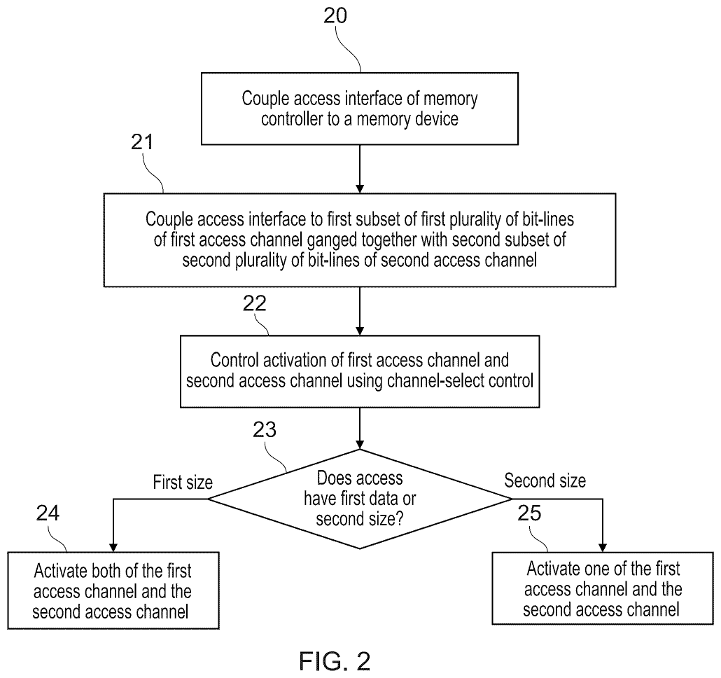

FIG. 2 is a flow diagram showing a sequence of steps that are taken in accordance with the method of some examples. Firstly, at step 20, the access interface of a memory controller is coupled to a memory device. Then, at step 21, the access interface of the memory controller is coupled to a first subset of a first plurality of bit-lines of a first access channel of the memory device ganged together with a second subset of a second plurality of bit-lines of a second access channel of the memory device. Then, at step 22, activation of the first access channel and the second access channel of the memory device is controlled using a channel-select control. At step 23 it is determined whether an access to be carried out has a first data size or a second data size. For the first data size, at step 24, both of the first access channel and the second access channel are activated. For the second data size, at step 25, one of the first access channel and the second access channel is activated.

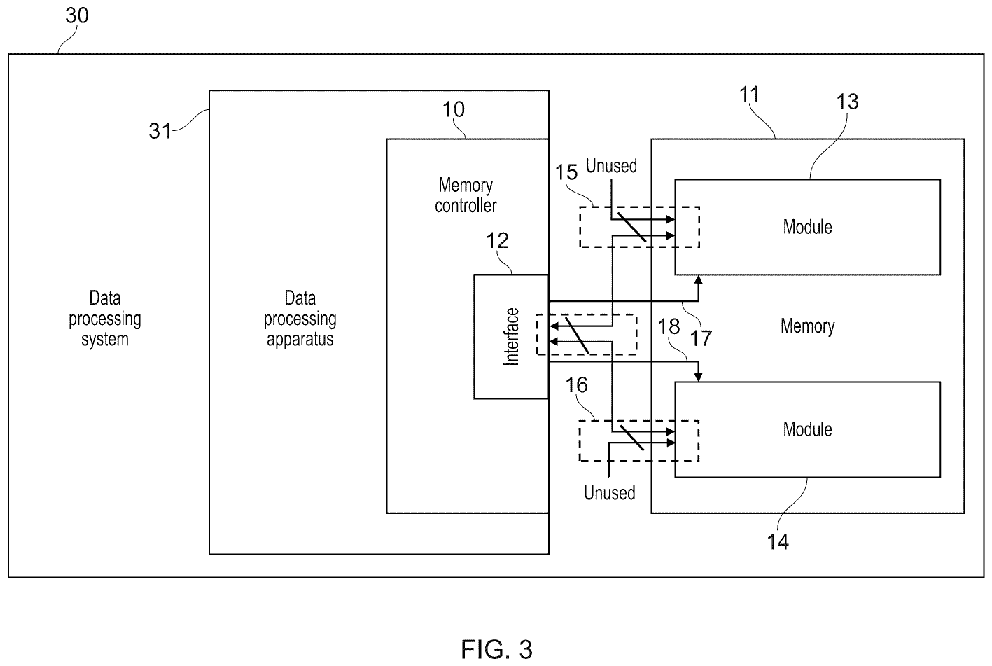

FIG. 3 schematically illustrates a data processing system 30 comprising a data processing apparatus 31, as well as the memory controller 10 and the memory device 11 described above with reference to FIG. 1. The memory device 11 is provided to support the data processing operations carried out by the data processing apparatus 31. Various types of memory device may be coupled to a memory controller in accordance with the present techniques, but by way of example, the memory device 11 is an LPDDR memory device, more specifically an LPDDR5 memory device.

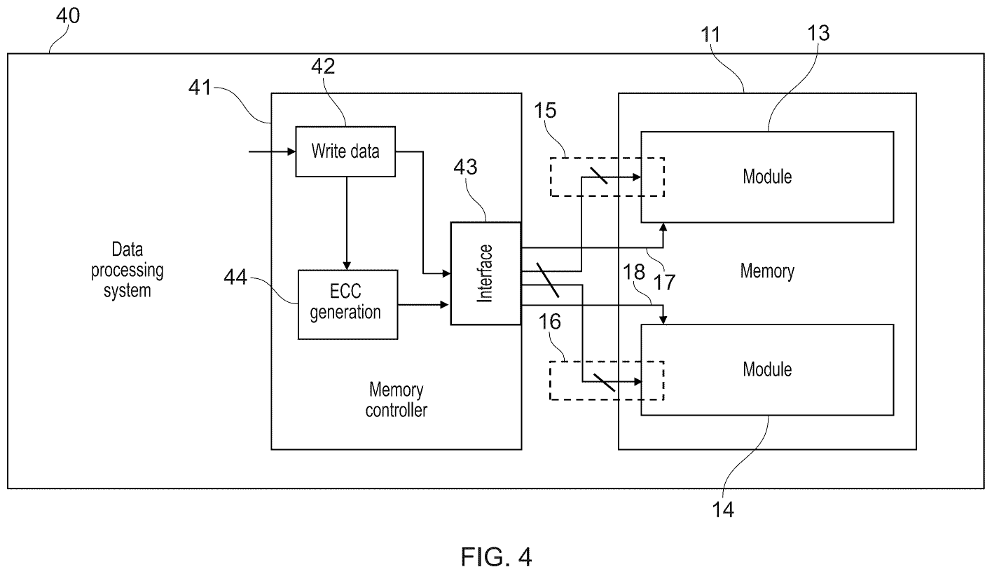

FIG. 4 schematically illustrates a data processing system 40 comprising a memory controller 41 and a memory device 11 in accordance with some examples. The memory device 11 is as described above with reference to FIG. 1. The components of the memory controller 41 shown in FIG. 4 illustrate an example in which the first type data is the object of the data processing carried out by the data processing system 40 and the second type data is error correction code data generated to protect the integrity of the first type data. Accordingly, the memory controller 41 receives write data 42, which is data to be written to the memory device 11, from the remainder of the data processing system (e.g. from a proceeding element—not shown). The write data 42 is provided to the interface 43 to be transferred to the memory device 11. The write data 42 is also provided to the error correction code (ECC) generation circuitry 44, which generates ECC data that is also passed to the interface 43. Both the write data 42 and the ECC data are then transferred to the memory device 11 from the interface 43. Further detail of the relative sizes of the write data 42 and the ECC data as well as of the scheduling of the transfer to the memory device 11 is given below with reference to the further figures.

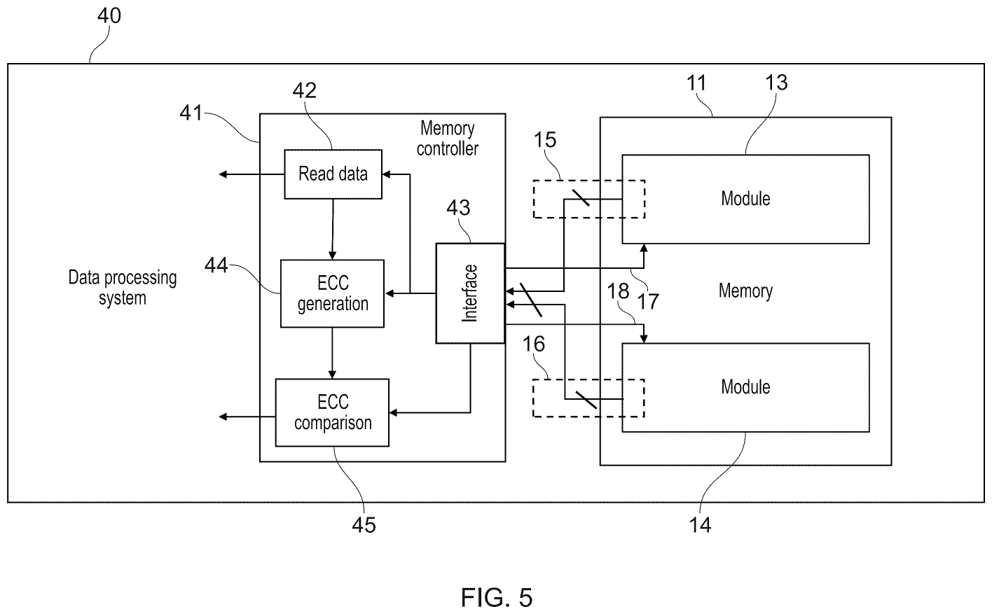

FIG. 5 schematically illustrates the data processing system 40 comprising the memory controller 41 and a memory device 11 as described above with reference to FIG. 4. The memory device 11 is thus as described above with reference to FIG. 1. The components of the memory controller 41 shown in FIG. 5 illustrate an example in which the first type data is the object of the data processing carried out by the data processing system 40 and for this purpose is read from the memory device 11 in order to be subjected to the desired processing. The second type data is error correction code (ECC) data which has previously been generated to protect the integrity of the first type data and has also been received from the memory device 11 by the interface 43. The ECC data may have been stored in association with the data it protects in the memory device 11 or may have been generated by the memory device 11 to protect data it has read out from the modules 13, 14 when that data is transferred to the interface 43. The read data 42 received by the interface 43 is temporarily buffered, as well as being passed to the ECC generation circuitry 44. The ECC generation circuitry thus generates ECC data using the read data 42. The interface 43 passes the ECC data received from the memory device 11 to the ECC comparison circuitry 45, which compares that received ECC data to the locally generated ECC data. When the two correspond, this is signalled to the data processing system (e.g. to a proceeding element—not shown) and the read data 42 can thus directly be used, its integrity having been confirmed. When the two do not correspond, this is also signalled to the data processing system (e.g. to a proceeding element—not shown) and the read data 42 can thus be handled appropriately (e.g. subjected to correction or discarded, etc.). In a variant, the ECC generation circuitry 44 may also perform error correction (where possible) on the received read data, thus passing the corrected (original) data to the data processing system, without the data processing system even being aware that error correction has taken place.

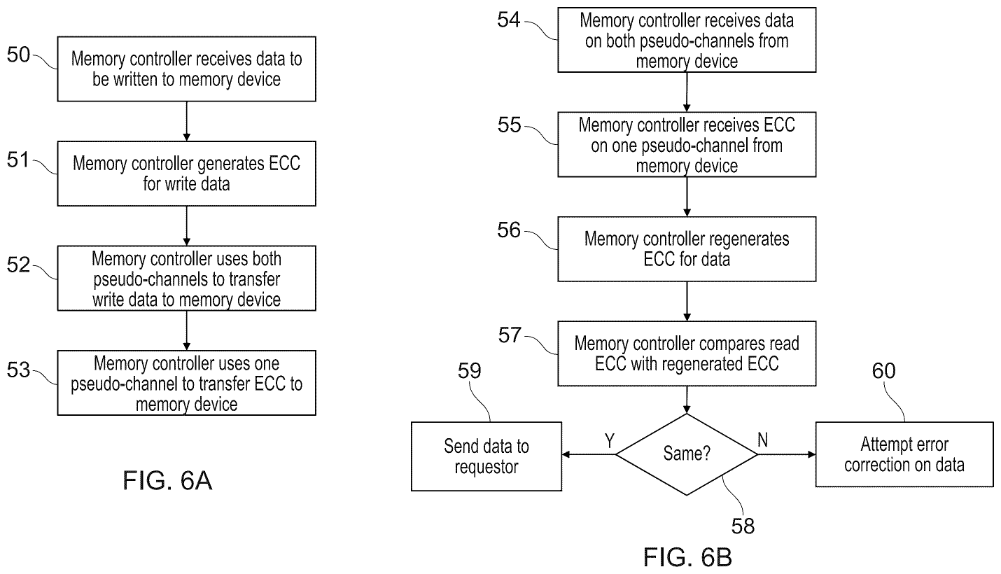

FIGS. 6A and 6B are flow diagrams each showing a sequence of steps that are taken in accordance with the method of some examples. FIG. 6A illustrates a process of writing data to a memory device. At step 50, a memory controller receives data to be written to a memory device. At step 51, the memory controller generates ECC data on the basis of the data to be written. Then, at step 52, the memory controller uses both pseudo-channels to transfer the write data to the memory device. At step 53, the memory controller uses one pseudo-channel to transfer the ECC to the memory device. Note that for clarity of illustration step 52 and 53 are shown as sequential, but their ordering is not essential or fixed as indeed will be elaborated on with respect to the figures that follow. FIG. 6B illustrates a process of receiving data from a memory device. At step 54, a memory controller receives data on both pseudo-channels coupled to its access interface from a memory device. At step 55, the memory controller receives ECC on one pseudo-channel from the memory device. Then at step 56, the memory controller regenerates the ECC for the data as received and at step 57 the received ECC is compared with the regenerated ECC. The result of that comparison determines, at step 58, whether the read data is simply passed on to the entity that has requested that data (step 59) or whether it is attempted to error correct the data (at step 60).

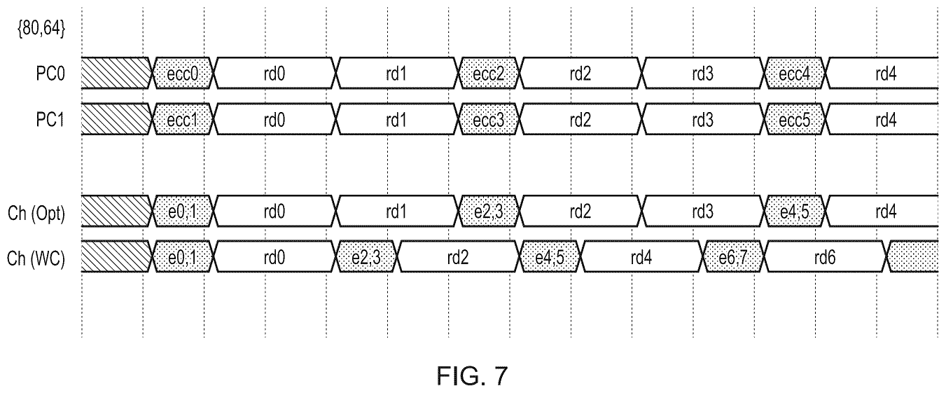

FIGS. 7, 8, and 9 illustrate the transmission of data and associated error correction code data via first and second pseudo-channels in accordance with some examples. The difference between the examples shown in these figures are the ECC encodings used, which are labelled in the form: {[total bits], [data bits]}. FIG. 7 shows an example of {80, 64} according to which 16 bits of ECC are used for each 64 bits of data. This allows for double error correction and triple error detection (DECTED) over a 64-bit word, or 16*8-bit symbols in a 64-byte line, offering 8 symbol corrections.

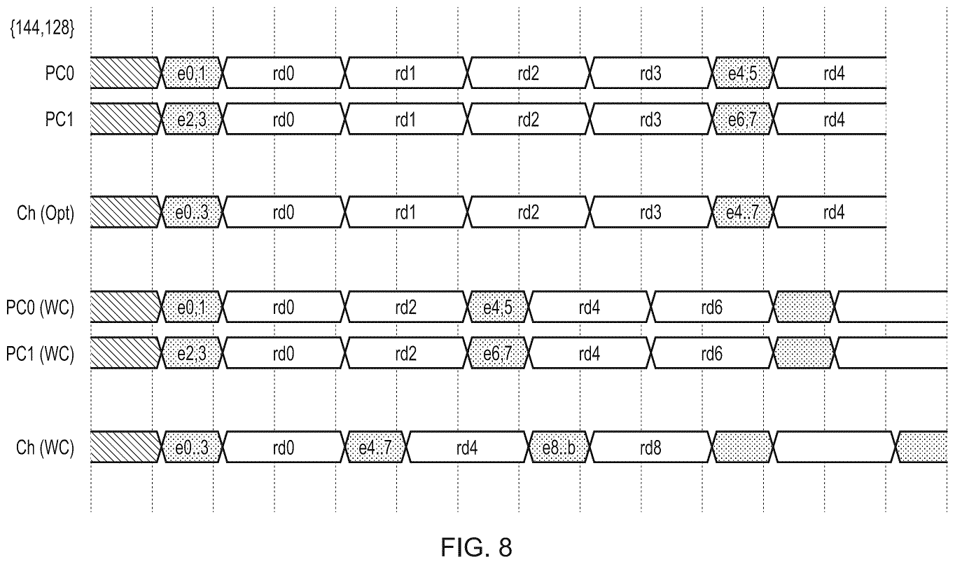

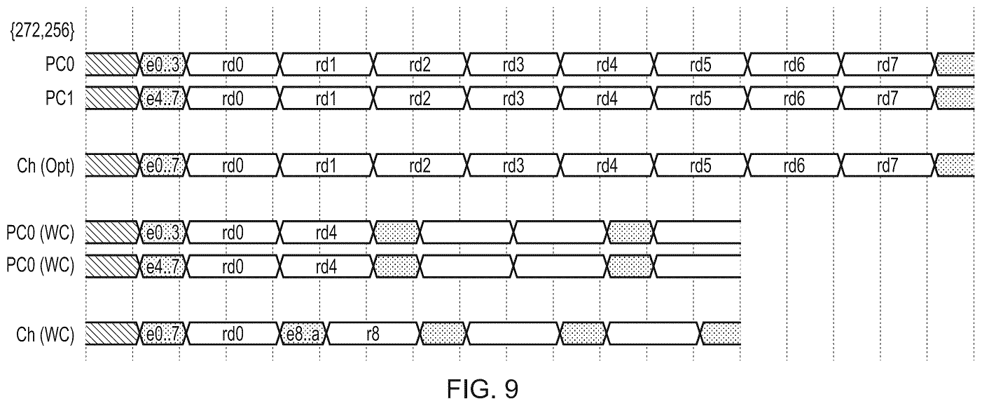

FIG. 8 shows an example of {144, 128} according to which 16 bits of ECC are used for each 128 bits of data. This allows for single error correction and double error detection (SECDED) over a 128-bit word, or 8*8-bit symbols in a 64-byte line, offering 4 symbol corrections. FIG. 9 shows an example of {272, 256} according to which 16 bits of ECC are used for each 256 bits of data. This allows for single error correction and double error detection (SECDED) over a 256-bit word, or 4*8-bit symbols in a 64-byte line, offering 2 symbol corrections. The waveforms in FIGS. 7, 8, and 9 show the difference between being able to exploiting data locality (“Opt”) and a worst-case (“WC”) where entirely random access is assumed. A 16-bit channel width and hence an 8-bit pseudo-channel width, together with a minimum burst length of 16 is assumed for the examples shown.

In the figures, the minimum unit of data transfer for each of the two pseudo-channels (PC0 and PC1) is of 8-bit*16 burst length=128 bits=16B. Hence, combined, transfers carried by the combined channel (Ch) are in 32B chunks. In FIG. 7, using the {80,64} encoding, in the optimal example exploiting data locality (Ch(Opt)), this enables 32B of ECC (<ecc0, ecc1>) to be transferred in a first burst, followed by a double length data burst (64B) using the whole channel width (<rd0>), and followed by another double length data burst (64B) using the whole channel width (<rd1>), where ecc[x] is the ECC protecting the data rd[x]. Note that “ecc[x], ecc[x+1]” is abbreviated as “e[x],[x+1]”. This pattern then repeats for <e2,3> and <rd2>, <rd3>, and so on.

Accordingly, when exploiting data locality, a bandwidth usage for the data transfers of ⅘=80% is achievable for this {80,64} encoding. Note that for the worst case of 64-byte random access (Ch(WC)), i.e. not benefiting from data locality, again a first block of ECC (<e0,1>) is transferred in a first burst, followed by a double length data burst using the whole channel width (<rd0>), but only the first part of the ECC (<e0>) is of use. This is then followed by another block of ECC (<e2,3>) transferred in a first burst, followed by a double length data burst using the whole channel width (<rd2>), where only the first part of the ECC (<e2>) is of use, and so on. Accordingly, for random access, a bandwidth usage for the data transfers of ⅔=66% is achieved for this {80,64} encoding.

Similarly, in FIG. 8, the minimum unit of data transfer for each of the two pseudo-channels (PC0 and PC1) is again 16B and, combined, transfers carried by the combined channel (Ch) are in 32B chunks. In FIG. 8, using the {144,128} encoding, in the optimal example exploiting data locality (Ch(Opt)), this enables 32B of ECC (<ecc0, ecc1, ecc2, ecc3>—abbreviated as <e0..3>) to be transferred in a first burst, followed by double length data bursts (64B) using the whole channel width for <rd0>, <rd1>, <rd2>, and <rd3>. This pattern then repeats for <e4..7> and <rd4>, <rd5>, <r6>, and <r7>, and so on. Accordingly, when exploiting data locality, a bandwidth usage for the data transfers of 8/9=89% is achievable for this {144,128} encoding. Note that for the worst case of 64-byte random access, i.e. not benefiting from data locality, making use of the pseudo-channels (PC0(WC) and PC1(WC)), first blocks of ECC <e0, 1> and <e2, 3> are transferred in a first burst, followed by double length data bursts (<rd0>, <rd2>), but only the first parts of the ECC carried by each pseudo-channel (ecc0 and ecc2) are of use. This is then followed by another block of ECC on each pseudo-channel <e4,5> and <6,7> transferred in a first burst, followed by double length data bursts (<rd4>, <rd6>), and again only the first part of the ECC carried by each pseudo-channel (ecc4 and ecc6) are of use, and so on. Accordingly, for random access using of the pseudo-channels, a bandwidth usage for the data transfers of 8/10=80% is achieved for this {144,128} encoding. Also shown in FIG. 8, for the worst case of 64-byte random access, i.e. not benefiting from data locality, and only making use of the full-width channel (Ch(WC)), a first block of ECC <e0..3> is transferred in a first burst, followed by a double length data burst (<rd0>), but only the first part of the ECC (ecc0) is of use. This is then followed by another block of ECC <e4..7> transferred in a first burst, followed by a double length data burst (<rd4>), and again only the first part of the ECC (ecc4) is of use, and so on. Accordingly, for random access using only the full-width channel, a bandwidth usage for the data transfers of ⅔=66% is achieved for this {144,128} encoding.

Further similarly, in FIG. 9, the minimum unit of data transfer for each of the two pseudo-channels (PC0 and PC1) is again 16B and, combined, transfers carried by the combined channel (Ch) are in 32B chunks. In FIG. 9, using the {272,256} encoding, in the optimal example exploiting data locality (Ch(Opt)), this enables 32B of ECC (<e0..7>) to be transferred in a first burst, followed by double length data bursts (64B) using the whole channel width for <rd0> to <rd7>. This pattern then repeats for <e8..f> and <rd8> to <rf>, and so on (NB: hexadecimal counting). Accordingly, when exploiting data locality, a bandwidth usage for the data transfers of 16/17=94% is achievable for this {272,256} encoding. Note that for the worst case of 64-byte random access, i.e. not benefiting from data locality, making use of the pseudo-channels (PC0(WC) and PC1(WC)), first blocks of ECC <e0..3> and <e4..7> are transferred in a first burst, followed by double length data bursts (<rd0>, <rd4>), but only the first parts of the ECC carried by each pseudo-channel (ecc0 and ecc4) are of use. This is then followed by another block of ECC on each pseudo-channel, followed by double length data bursts, and so on. Accordingly, for random access using of the pseudo-channels, a bandwidth usage for the data transfers of 8/10=80% is achieved for this {272,256} encoding. Also shown in FIG. 9, for the worst case of 64-byte random access, i.e. not benefiting from data locality, and only making use of the full-width channel (Ch(WC)), a first block of ECC <e0..7> is transferred in a first burst, followed by a double length data burst (<rd0>), but only the first part of the ECC (ecc0) is of use. This is then followed by another block of ECC <e8..a> transferred in a first burst, followed by a double length burst (<rd8>), and again only the first part of the ECC (ecc8) is of use, and so on. Accordingly, for random access using only the full-width channel, a bandwidth usage for the data transfers of ⅔=66% is achieved for this {272,256} encoding. On this basis, when comparing the range of performance (random access to full data locality) and maximum data capacity, the advantage of the {272,256} encoding over the {80,64} and {144,128} will be appreciated, since 66-94% performance with 94% maximum data capacity with normal channel operation and 80-94% performance with 94% maximum data capacity with pseudo-channel operation are achieved.

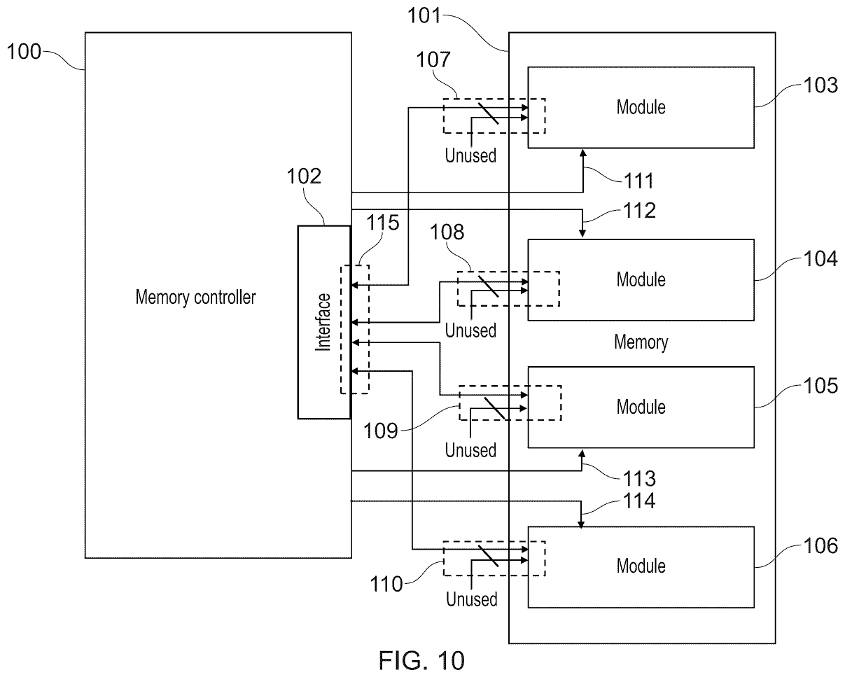

FIG. 10 schematically illustrates a memory controller 100 and a memory device 101 in accordance with some examples. The memory controller 100 comprises an access interface 102 via which it is coupled to the memory device 101. The memory device 101 is a four-channel package comprising four memory modules 103, 104, 105, 106. Each memory module has a respective access channel 107, 108, 109, 110 comprising a plurality of bit-lines. The memory controller 100 controls activation of the access channels via a channel-select control, which itself comprises respective signals 111, 112, 113, 114. Only part of each of the access channels 107-110 are coupled to the access interface 115. This may be achieved by running the four-channel package in “byte-mode”, with only one byte lane from each channel actively used. In the example shown each of the access channels 107-110 has a 16-bit width of which an 8-bit half of each are ganged together to couple to the 32-bit width access interface 115. Individual, groupd of, or all of the channel-select control signals 111-114 can be asserted and a given data block can thus either be transferred via just one of the access channels (at 8-bit width), shared across two (at 16-bit width), or shared across all four (at 32-bit width). The four access channels 107-110 thus operate as pseudo-channels. Accesses to the memory device 101 are constrained to have a minimum burst length of 16 in the example shown, such that an access using just one access channel has a minimum 16B block size, an access using two access channels has a minimum 32B block size, and an access using four access channels has a minimum 64B block size. As in the other example configurations herein, the memory controller 100 is configured to assert the channel-select signals in dependence on the size of a given access

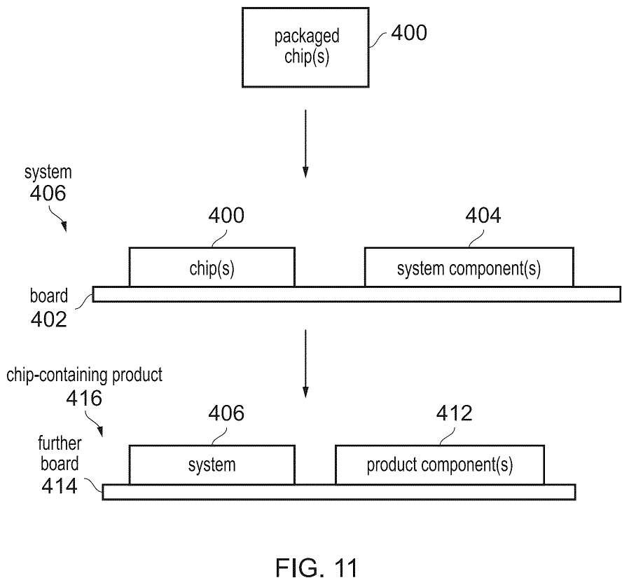

FIG. 11 schematically illustrates a system comprising an implementation in a packaged chip and an implementation in a chip-containing product in accordance with some examples. Concepts described herein may be embodied in a system comprising at least one packaged chip. The memory controllers described earlier are implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

As shown in FIG. 11, one or more packaged chips 400, with the memory controller described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the memory controller described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers). In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor. A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414. The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Various configurations are set out in the following numbered clauses:
Clause 1. A memory controller comprising:
   an access interface for coupling to a memory device, the memory device having:
      a first access channel comprising a first plurality of bit-lines; and
      a second access channel comprising a second plurality of bit-lines;
   a channel-select control configured to control activation of the first access channel and of the second access channel; and
   the access interface is configured to couple to a first subset of the first plurality of bit-lines of the first access channel ganged together with a second subset of the second plurality of bit-lines of the second access channel,
   wherein an access to the memory device is constrained to have a minimum burst length comprising multiple data words,
   and wherein the memory controller is configured to use the channel-select control to activate both of the first access channel and the second access channel when the access has a first data size; and
   and wherein the memory controller is configured to use the channel-select control to activate one of the first access channel and the second access channel when the access has a second data size which is less than the first data size.
Clause 2. The memory controller as defined in Clause 1, further configured, when two accesses of the second data size to the memory device are to be performed, to use the channel-select control to activate the first access channel for a first access of the two accesses and to activate the second access channel for a second access of the two accesses.
Clause 3. The memory controller as defined in Clause 1 or Clause 2,
   wherein the access having the first data size comprises first type data; and
   wherein the access having the second data size comprises second type data.
Clause 4. The memory controller as defined in Clause 3, further comprising second type data generation circuitry.
Clause 5. The memory controller as defined in Clause 4, further configured, when the access is a write access to the memory device, to receive the first type data destined for the memory device, and the second type data generation circuitry is configured to generate the second type data from the first type data.
Clause 6. The memory controller as defined in Clause 4, wherein when the access is a read access from the memory device:
   the memory controller is configured to receive the first type data and the second type data from the memory device;
   the second type data generation circuitry is configured to generate verification second type data from the first type data; and
   the memory controller is configured to compare the second type data with the verification second type data.
Clause 7. The memory controller as defined in Clause 5, when dependent on Clause 2,
   wherein the second type data generation circuitry is configured to generate a first instance of the second type data from a first instance of the first type data and to generate a second instance of the second type data from a second instance of the first type data,
   and the memory controller is configured to transmit the first instance of the second type data and the second instance of the second type data as the two accesses of the second data size in parallel via the first access channel and the second access channel respectively,
   and to transmit the first instance of the first type data via both the first access channel and the second access channel followed by the second instance of the first type data via both the first access channel and the second access channel.
Clause 8. The memory controller as defined in any of Clauses 4-7, wherein the second data type generation circuitry is error correction code generation circuitry and the second type data is error correction code for the first type data.
Clause 9. The memory controller as defined in Clause 8, wherein the error correction code generation circuitry is configured to generate the error correction code in a 16:64 bit ratio for the first type data,
   and wherein the memory controller is configured to transmit a first error correction code for a first data packet and a second error correction code for a second data packet in parallel via the first access channel and the second access channel respectively,
   and to transmit the first data packet via both the first access channel and the second access channel followed by the second data packet via both the first access channel and the second access channel.
Clause 10. The memory controller as defined in Clause 8, wherein the error correction code generation circuitry is configured to generate the error correction code in a 16:128 bit ratio for the first type data,
   and wherein the memory controller is configured to transmit a first error correction code for a first data packet and a second error correction code for a second data packet via the first access channel and in parallel to transmit a third error correction code for a third data packet and a fourth error correction code for a fourth data packet via the second access channel respectively,
   and to transmit the first data packet, the second data packet, the third data packet and the fourth data packet sequentially via both the first access channel and the second access channel.
Clause 11. The memory controller as defined in Clause 8, wherein the error correction code generation circuitry is configured to generate the error correction code in a 16:256 bit ratio for the first type data,
   and wherein the memory controller is configured to transmit 1st to 4th error correction codes for 1st to 4th data packets via the first access channel and in parallel to transmit 5th to 8th error correction codes for 5th to 8th data packets via the second access channel respectively,
   and to transmit the 1st to 8th data packets sequentially via both the first access channel and the second access channel.
Clause 12. The memory controller as defined in any preceding Clause, wherein the access interface for coupling to the memory device is configured for coupling to the memory device further having:
   a third access channel comprising a third plurality of bit-lines; and
   a fourth access channel comprising a fourth plurality of bit-lines;
   the channel-select control is further configured to control activation of the third access channel and of the fourth access channel; and
   the access interface is further configured to couple to a first subset of the third plurality of bit-lines of the third access channel ganged together with a second subset of the fourth plurality of bit-lines of the third access channel,
   wherein the access comprises a first access and a second access,
   and wherein the memory controller is configured to use the channel-select control to activate both of the third access channel and the fourth access channel when the second access has the first data size; and
   and wherein the memory controller is configured to use the channel-select control to activate one of the third access channel and the fourth access channel when the second access has the second data size.
Clause 13. The memory controller as defined in any preceding Clause, wherein the memory device is an LPDDR memory device.
Clause 14. The memory controller as defined in Clause 13, wherein the memory device is an LPDDR5 memory device.
Clause 15. The memory controller as defined in any preceding Clause, wherein the minimum burst length is 16.
Clause 16. The memory controller as defined in any preceding Clause, wherein the memory device is configured to operate in byte-mode.
Clause 17. A method of operating a memory controller comprising:
   coupling an access interface of the memory controller to a memory device, the memory device having:
      a first access channel comprising a first plurality of bit-lines; and
      a second access channel comprising a second plurality of bit-lines;
   controlling activation of the first access channel and of the second access channel using a channel-select control;
   coupling the access interface to a first subset of the first plurality of bit-lines of the first access channel ganged together with a second subset of the second plurality of bit-lines of the second access channel,
   wherein an access to the memory device is constrained to have a minimum burst length comprising multiple data words;
   using the channel-select control to activate both of the first access channel and the second access channel when the access has a first data size; and
   using the channel-select control to activate one of the first access channel and the second access channel when the access has a second data size which is less than the first data size.
Clause 18. A memory device comprising:
   a first access channel comprising a first plurality of bit-lines; and
   a second access channel comprising a second plurality of bit-lines;
   a channel-select control line to control activation of the first access channel and of the second access channel; and
   a first subset of the first plurality of bit-lines of the first access channel is ganged together with a second subset of the second plurality of bit-lines of the second access channel,
   wherein an access to the memory device is constrained to have a minimum burst length comprising multiple data words,
   and wherein when the access has a first data size the channel-select control line activates both of the first access channel and the second access channel; and
   and wherein when the access has a second data size which is less than the first data size the channel-select control line activates one of the first access channel and the second access channel.
Clause 19. A system comprising:
   the memory controller of any of Clauses 1-16, implemented in at least one packaged chip;
   at least one system component; and
   a board,
   wherein the at least one packaged chip and the at least one system component are assembled on the board.
Clause 20. A chip-containing product comprising the system of Clause 19, wherein the system is assembled on a further board with at least one other product component.

In brief overall summary memory controllers, methods of operating memory controllers, memory devices, systems, and chip-containing products are disclosed. An access interface couples to a memory device having first and second access channels each comprising a plurality of bit-lines. A channel-select control controls activation of the first and second access channels. The access interface couples to a first subset of the first plurality of bit-lines of the first access channel ganged together with a second subset of the second plurality of bit-lines of the second access channel. Accesses to the memory device are constrained to have a minimum burst length comprising multiple data words. The channel-select control is used to activate both of the first and second access channels when the access has a first data size and to activate one of the first and second access channels when the access has a second data size which is less than the first data size.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

I claim:

1. A memory controller comprising:
an access interface for coupling to a memory device, the memory device having:
a first access channel comprising a first plurality of bit-lines; and
a second access channel comprising a second plurality of bit-lines;
a channel-select control configured to control activation of the first access channel and of the second access channel; and
the access interface is configured to couple to a first subset of the first plurality of bit-lines of the first access channel ganged together with a second subset of the second plurality of bit-lines of the second access channel,
wherein an access to the memory device is constrained to have a minimum burst length comprising multiple data words,
and wherein the memory controller is configured to use the channel-select control to activate both of the first access channel and the second access channel when the access has a first data size; and
and wherein the memory controller is configured to use the channel-select control to activate one of the first access channel and the second access channel when the access has a second data size which is less than the first data size.

2. The memory controller as claimed in claim 1, further configured, when two accesses of the second data size to the memory device are to be performed, to use the channel-select control to activate the first access channel for a first access of the two accesses and to activate the second access channel for a second access of the two accesses.

3. The memory controller as claimed in claim 1,
wherein the access having the first data size comprises first type data; and
wherein the access having the second data size comprises second type data.

4. The memory controller as claimed in claim 3, further comprising second type data generation circuitry.

5. The memory controller as claimed in claim 4, further configured, when the access is a write access to the memory device, to receive the first type data destined for the memory device, and the second type data generation circuitry is configured to generate the second type data from the first type data.

6. The memory controller as claimed in claim 4, wherein when the access is a read access from the memory device:
the memory controller is configured to receive the first type data and the second type data from the memory device;
the second type data generation circuitry is configured to generate verification second type data from the first type data; and
the memory controller is configured to compare the second type data with the verification second type data.

7. The memory controller as claimed in claim 5, further configured, when two accesses of the second data size to the memory device are to be performed, to use the channel-select control to activate the first access channel for a first access of the two accesses and to activate the second access channel for a second access of the two accesses,
wherein the second type data generation circuitry is configured to generate a first instance of the second type data from a first instance of the first type data and to generate a second instance of the second type data from a second instance of the first type data,
and the memory controller is configured to transmit the first instance of the second type data and the second instance of the second type data as the two accesses of the second data size in parallel via the first access channel and the second access channel respectively,
and to transmit the first instance of the first type data via both the first access channel and the second access channel followed by the second instance of the first type data via both the first access channel and the second access channel.

8. The memory controller as claimed in claim 4, wherein the second data type generation circuitry is error correction code generation circuitry and the second type data is error correction code for the first type data.

9. The memory controller as claimed in claim 8, wherein the error correction code generation circuitry is configured to generate the error correction code in a 16:64 bit ratio for the first type data,
and wherein the memory controller is configured to transmit a first error correction code for a first data packet and a second error correction code for a second data packet in parallel via the first access channel and the second access channel respectively,
and to transmit the first data packet via both the first access channel and the second access channel followed by the second data packet via both the first access channel and the second access channel.

10. The memory controller as claimed in claim 8, wherein the error correction code generation circuitry is configured to generate the error correction code in a 16:128 bit ratio for the first type data,
and wherein the memory controller is configured to transmit a first error correction code for a first data packet and a second error correction code for a second data packet via the first access channel and in parallel to transmit a third error correction code for a third data packet and a fourth error correction code for a fourth data packet via the second access channel respectively,
and to transmit the first data packet, the second data packet, the third data packet and the fourth data packet sequentially via both the first access channel and the second access channel.

11. The memory controller as claimed in claim 8, wherein the error correction code generation circuitry is configured to generate the error correction code in a 16:256 bit ratio for the first type data,
and wherein the memory controller is configured to transmit 1^{st} to 4^{th} error correction codes for 1^{st} to 4^{th} data packets via the first access channel and in parallel to transmit 5^{th} to 8^{th} error correction codes for 5^{th} to 8^{th} data packets via the second access channel respectively,
and to transmit the 1^{st} to 8^{th} data packets sequentially via both the first access channel and the second access channel.

12. The memory controller as claimed in claim 1, wherein the access interface for coupling to the memory device is configured for coupling to the memory device further having:
a third access channel comprising a third plurality of bit-lines; and
a fourth access channel comprising a fourth plurality of bit-lines;
the channel-select control is further configured to control activation of the third access channel and of the fourth access channel; and
the access interface is further configured to couple to a first subset of the third plurality of bit-lines of the third access channel ganged together with a second subset of the fourth plurality of bit-lines of the third access channel,
wherein the access comprises a first access and a second access,
and wherein the memory controller is configured to use the channel-select control to activate both of the third access channel and the fourth access channel when the second access has the first data size; and
and wherein the memory controller is configured to use the channel-select control to activate one of the third access channel and the fourth access channel when the second access has the second data size.

13. The memory controller as claimed in claim 1, wherein the memory device is an LPDDR memory device.

14. The memory controller as claimed in claim 13, wherein the memory device is an LPDDR5 memory device.

15. The memory controller as claimed in claim 1, wherein the minimum burst length is 16.

16. The memory controller as claimed in claim 1, wherein the memory device is configured to operate in byte-mode.

17. A method of operating a memory controller comprising:
coupling an access interface of the memory controller to a memory device, the memory device having:
a first access channel comprising a first plurality of bit-lines; and
a second access channel comprising a second plurality of bit-lines;
controlling activation of the first access channel and of the second access channel using a channel-select control;
coupling the access interface to a first subset of the first plurality of bit-lines of the first access channel ganged together with a second subset of the second plurality of bit-lines of the second access channel,
wherein an access to the memory device is constrained to have a minimum burst length comprising multiple data words;
using the channel-select control to activate both of the first access channel and the second access channel when the access has a first data size; and
using the channel-select control to activate one of the first access channel and the second access channel when the access has a second data size which is less than the first data size.

18. A memory device comprising:
a first access channel comprising a first plurality of bit-lines; and
a second access channel comprising a second plurality of bit-lines;
a channel-select control line to control activation of the first access channel and of the second access channel; and
a first subset of the first plurality of bit-lines of the first access channel is ganged together with a second subset of the second plurality of bit-lines of the second access channel,
wherein an access to the memory device is constrained to have a minimum burst length comprising multiple data words,
and wherein when the access has a first data size the channel-select control line activates both of the first access channel and the second access channel; and
and wherein when the access has a second data size which is less than the first data size the channel-select control line activates one of the first access channel and the second access channel.

19. A system comprising:
the memory controller of claim 1, implemented in at least one packaged chip;
at least one system component; and
a board,
wherein the at least one packaged chip and the at least one system component are assembled on the board.

20. A chip-containing product comprising the system of claim 19, wherein the system is assembled on a further board with at least one other product component.
